(19) United States
(12) Patent Application Publication
(10) Pub. No.: US 2004/0228024 A1
(43) Pub. Date: Nov. 18, 2004

(54) Magnetization control method and information recording apparatus

(75) Inventors: Susumu Ogawa, Fujimi (JP); Tomihiro Hashizume, Hatoyama (JP); Masahiko Ichimura, Sendai (JP); Toshiyuki Onogi, Higashimatsuyama (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 10/714,932

(22) Filed: Nov. 18, 2003

(30) Foreign Application Priority Data
May 14, 2003 (JP) 2003-135434

(51) Int. Cl. G11B 5/02

(52) U.S. Cl. 360/69

(57) ABSTRACT

In place of a magnetic field in which it is difficult to write onto and read a hard disk at high density, there is provided an information storage apparatus capable of writing and reading by means of a metal probe which applies a voltage to a thin film structure in a non contact manner to change the relative magnetization direction in the thin film layers to store information. Changes in a tunnel current between the thin film layers is then used to detect the relative magnetization direction and to read the stored information. At least a three-layer thin film structure including a magnetic metallic layer, a non-magnetic metallic layer and a magnetic metallic layer may be formed. A metal probe is brought close to the surface of this multilayer film at distance on the order of one nanometer. The distance between the metal probe and the surface of the multilayer film and applied voltage are changed, whereby a quantum well state which occurs in the multilayer film is changed to change relative magnetization between magnetic metallic layers. In order to read magnetization information, there will be utilized a change in tunnel current which flows between the metal probe and the multilayer film which results from a change in a quantum well level due to a change in the relative direction of magnetization between magnetic metallic layers.

### PRIORITY CLAIM

The present invention claims priority under 35 USC 119, to Japanese patent application P2003-135434 filed May 14, 2003; the entire disclosure of which is hereby incorporated herein by reference.

### FIELD OF THE INVENTION.

The present invention relates to a method for writing and reading magnetization information and an apparatus for the same. For example, the present invention could be used in a disk drive.

### BACKGROUND OF THE INVENTION

In order to write magnetization information in a conventional hard disk drive unit (HDD), a writing technique has been used in which a magnetic head uses a magnetic field generated from a coil. If the HDD is requested for higher density recording, it is known that when the magnetic head becomes finer, corresponding to a finer recording domain due to a trend toward higher density, that the intensity of a magnetic field which can be generated from the magnetic head is reduced under the influence of a demagnetizing field component which occurs at the tip end of the magnetic head. Also, when the recording domain becomes finer, material having greater magnetic anisotropy will be required in order to overcome thermal instability of the direction of magnetization written, and therefore, a larger writing magnetic field will be required. Therefore, in magnetization writing methods for high-density recording, a writing technique, which substitutes for the conventional magnetic head, is needed.

On the other hand, even in a solid memory using non-volatile magnetization for a magnetic random access memory (MRAM), it is known that in the magnetization writing technique using conventional current, power consumption will be increased along with the trend discussed above of tending towards recording domains being rendered finer.

As an alternate technique to substitute for these magnetization writing techniques which use a magnetic field to be generated from a current, there has been proposed a writing technique using spin injection magnetized inversion. Although this is a technique for performing magnetized inversion by injecting a spin polarized electron into magnetic material for writing, it is essentially difficult to reduce the power consumption because the writing current threshold is as great as 10 ⁷A/cm².

As another writing technique, there has been proposed a magnetization control technique using an electric field. For example, according to a non-patent literature 1, Mattsonet et al, Phys. Rev. Lett. 71, 185 (1993), in a laminated structure comprising ferromagnetic material metal, semiconductor material, and ferromagnetic material metal, the carrier concentration in the semiconductor layer is controlled by an electric field, and whereby an exchange interaction occurs between the ferromagnetic materials is controlled.

Also, for example, according to a non-patent literature 2, Chun-Yoel Youi et al., J. Appl. Phys., 87, 5215 (2000), within a three-layer structure comprising: ferromagnetic material metal, non-magnetic metal, and ferromagnetic material metal, there is also provided an insulating material layer so that the structure comprises: the ferromagnetic material metal, the non-magnetic metal, an insulating material layer and the ferromagnetic material metal. A voltage is applied between the ferromagnetic material metallic layers, whereby an exchange interaction which occurs between the ferromagnetic materials is controlled.

Also, for example, according to a patent literature 1, JP-A No. 196661/2001, U.S. Pat. No. 6,480,412, outside a three-layer structure of ferromagnetic material, i.e., a metal, non-magnetic metal, and ferromagnetic material metal, there is provided a semiconductor layer, and also where a width and height of a Schottkey barrier gate, which occurs on an interface between the ferromagnetic material metallic layer and the semiconductor, are controlled by the electric field, whereby an exchange interaction which occurs between the ferromagnetic materials is controlled.

[Patent Literature 1] JP-A No. 196661/2001

[Patent Literature 1] JP-A No. 73906/1999

[Non-Patent Literature 1] Mattsonet et al, Phys. Rev. Lett. 71, 185 (1993)

[Non-Patent Literature 2] Chun-Yoel Youi et al., J. Appl. Phys., 87, 5215 (2000)

### SUMMARY OF THE INVENTION

Inside or outside the above-described three-layer structure comprising a ferromagnetic material metal, non-magnetic metal, and a ferromagnetic material metal, there is provided a semiconductor layer or an insulating layer, and in order to enable magnetization control due to a voltage, when there is provided a semiconductor layer or an insulating layer inside, its thickness must be exceedingly thin, i.e., about 2 nm or less. Also, even when there is provided a semiconductor layer outside, since a quantum well state which is sensitive to the film thickness is utilized, it is necessary to form a steep metal to a semiconductor interface at an atomic layer level. It is very difficult to constitute such structure with stability.

In the technique disclosed in patent literature 1 which controls the potential on the interface by providing a semiconductor layer of Ge, the positive and negative of a magnetic exchange interaction between ferromagnetic metallic layers falls short of being reversed.

The present invention has been proposed in view of these problems of conventional techniques, and is aimed to provide a method for controlling magnetization by means of an electric field without providing a potential control layer such as a semiconductor which is difficult to fabricate adjacent to the three-layer structure comprising ferromagnetic material metal, non-magnetic metal and ferromagnetic material metal, and an information storage apparatus using the same.

In order to achieve the above-described object, in the present invention, a quantization electron state in a multilayer film having at least a three-layer thin film structure comprising a ferromagnetic metal, anon-magnetic metal, and a ferromagnetic metal is controlled by the metal probe which has been brought close to the surface of multilayer film. Outside this three-layer thin film structure, there may exist a protection film of, for example, Au.

It has been known already that by a combination of ferromagnetic metal and non-magnetic metal, a quantum well level may be formed in the non-magnetic metallic thin film. To this three-layer thin film structure or a multilayer film including a protection film, a metal probe is brought close. When the metal probe is brought close to this multilayer film on the order of 0 to 10 nm and further an electric field is applied, it is possible to modulate image potential on the surface of the multilayer film. Since this image potential has electrons confined in the multilayer film, when this potential is modulated, the confinement condition of electrons changes. As a result, energy of the quantum level which has been formed in the multilayer film changes, and it is possible to change positive and negative of the exchange interaction exerting on between the ferromagnetic metals.

### BRIEF DESCRIPTION OF THE DRAWINGS

FIG. 1 is a conceptual view showing a magnetic storage disk 50 of the first example, a metal probe 5 to be provided facing the magnetic storage disk 50 and their control-related structure;

FIG. 2 is a view showing a calculation example of magnitude of a magnetic exchange interaction J exerting on between ferromagnetic metallic layers 1 and 3 when height (eV) of a potential barrier on the surface of a multilayer film 41 without protection film 4 has been changed due to distance between the metal probe 5 and the surface of the multilayer film 41;

FIG. 3 is a view showing a direction of relative magnetization M of ferromagnetic metallic layers 1 and 3 when potential V of the metal probe 5 has been changed;

FIG. 4 is a view showing an example of a magnetic storage disk 50 in which a magnetic storage disk 50 shown in FIG. 1 has been formed with an anti-ferromagnetic layer 51;

FIG. 5 is a view showing an example in which the protection film 4 and the ferromagnetic layer 3 of the magnetic storage disk 50 shown in FIG. 4 have been patterned in a dot shape;

FIG. 6 is a perspective view showing an outline of structure of the magnetic recording device according to the fourth example of the present invention;

FIG. 7 is a perspective view showing an outline of structure of the magnetic recording device according to the fifth example of the present invention;

FIG. 8 is a perspective view showing an outline of structure of the magnetic recording device according to the sixth example of the present invention; and

FIG. 9 is a perspective view showing an outline of structure of the magnetic recording device according to the seventh example of the present invention.

### DETAILED DESCRIPTION OF THE PREFERRED EMBODIMENTS

With reference to the drawings, the description will be made of a principle of magnetization control due to an applied electric field using a metal probe according to the present invention.

(First Embodiment)

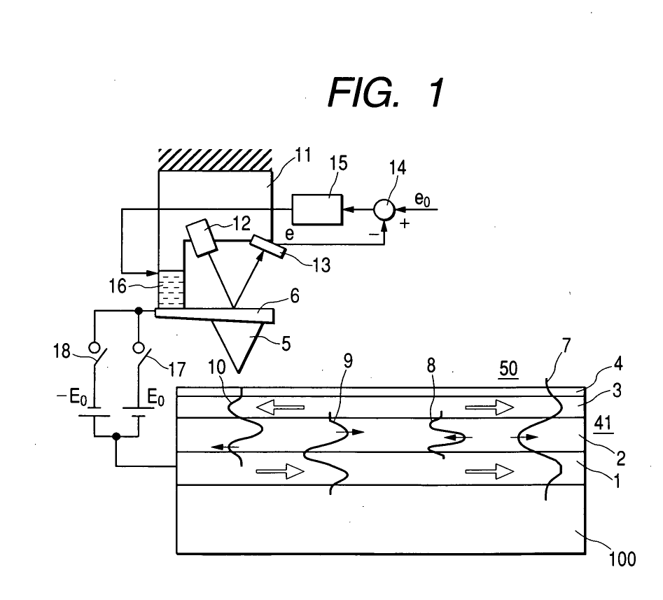

With reference to FIGS. 1 to 3, the description will be made of a first embodiment. FIG. 1 is a conceptual view showing a magnetic storage disk 50 of the first embodiment, a metal probe 5 to be provided facing the magnetic storage disk 50 and their control-related structure. The magnetic storage disk 50 is constituted by a multilayer film 41 composed of a ferromagnetic metallic layer 1, a non-magnetic metallic layer 2, a ferromagnetic metallic layer 3, and a protection film 4 which have been formed on a substrate 100. In opposite to the surface of the protection film 4 of the multilayer film 41, there is arranged a metal probe 5 at as exceedingly short distance as 1 nm level. The metal probe 5 is held and controlled in the same manner as a probe of a so-called atomic force microscope (AFM). Its outline is as follows: the metal probe 5 is fixed to the tip end of a leaf spring 6, and the other end of the leaf spring 6 is fixed to a movable end of a piezo element 16. The other end of the piezo element 16 is fixed to one portion of a holder 11. A surface on the opposite side to an end portion to which the piezo element 16 of the holder 11 is fixed is fixed to a fixing portion of a device shown by the hatched area in the figure. On the side of an end portion to which the piezo element 16 of the holder 11 is fixed, there are provided a semiconductor laser 12 and a position sensor 13.

A laser beam of light to be irradiated by the semiconductor laser 12 is reflected by a back surface of the leaf spring 6 which holds the above-described metal probe 5 to be detected by a position sensor 13. The semiconductor laser 12 and the position sensor 13 are arranged so as to output voltage e in response to distance between the protection film 4 and the metal probe 5. This voltage e and target voltage e₀ are applied to an adder 14 in a reverse sign as shown in the figure. Reference numeral 15 designates a control circuit having an integral action, which changes the output until error voltage to be given by the adder 14 becomes zero. If when input voltage to the control circuit 15 becomes zero and the piezo element 16 is in state corresponding to the output from the control circuit 15 in that state, the target voltage e₀ is increased, the output from the control circuit 15 will be increased by that much and the piezo element 16 will become longer. As a result, a position of the laser beam of light which the position sensor 13 receives changes, and the voltage e will increase. When an increment of the voltage e becomes equal to an increment of the target voltage e₀, the integral action of the control circuit 15 stops to be stabilized in the state. In other words, if the target voltage e₀ is selected to become a value corresponding to distance (1 nm) between surface of the protection film 4 of the multilayer film 41 and the metal probe 5, a state in which distance between the two is kept to be 1 nm will enter.

Since when distance between the protection film 4 and the metal probe 5 is about 1 nm in distance, an attractive (Van der Waals) force is exerted on between the two, thus if the position of the magnetic storage disk 50 changes, distance between the protection film 4 and the metal probe 5 becomes larger, the metal probe 5 will move so as to follow the surface of the multilayer film 41. At this time, in response to displacement in a position of the laser beam of light which is irradiated by the semiconductor laser 12-to which the position sensor 13 is subjected, the voltage e to be outputted from the position sensor 13 will increase. Conversely, if the distance between the protection film 4 and the metal probe 5 becomes smaller, the metal probe 5 will move-(non-contact mode) toward the surface of the multilayer film 41 because of the further increased attractive force. At this time, in response to displacement in a position of the laser beam of light which is irradiated by the semiconductor laser 12 to which the position sensor 13 is subjected, the voltage e to be outputted from the position sensor 13 will further increase. Since in response to this change, the piezo element 18 becomes longer, or shorter, the distance between the surface of the protection film 4 and the metal probe 5 is maintained at a predetermined value. In order to control the distance between the protection film 4 and the metal probe 5, in the present invention a tunnel current may be used, and a probe for controlling the distance may be prepared separately from the metal probe 5 for controlling the electric field to be described hereinafter.

For the ferromagnetic metallic layers 1 and 3 of the multilayer film 41, ferromagnetic simple metal or its alloy of, for example, Fe, Co, Ni, and the like can be used. For the nonmagnetic metallic layer 2, metal such as, for example, Au, Ag, Cu and Pt can be used. The protection film 4 is made of non-magnetic noble metal such as, for example, Au, but the protection film 4 may be dispensed with.

Electrons in the vicinity of Fermi-level in the multilayer film 41 are confined in the multilayer film 41, and form quantum well state 7 to 10 schematically shown in FIG. 1.

A right half domain of FIG. 1 indicates a case where directions of magnetization of the ferromagnetic metallic layers 1 and 3 are in parallel and in the same direction as shown by thick arrows, and in this case, an electron having an opposite electron spin as a thin arrow parallel with the magnetization is substantially confined in the nonmagnetic metallic layer 2 as indicated by a reference symbol 8. In contrast to this, an electron having such electron spin as a thin arrow in parallel but in the same directions with the magnetization is confined in the entire multilayer film 41 as indicated by a reference symbol 7.

On the other hand, a left half domain of FIG. 1 indicates a case where directions of magnetization of the ferromagnetic metallic layers 1 and 3 are in parallel but in opposite directions, and in this case, the electron is confined in the films 1 to 2 as indicated by a reference symbol 9 depending upon the direction of the spin, or is confined in the films 2 to 3 as indicated by a reference symbol 10.

A state of electrons forming these quantum wells does not only depend on the directions of magnetization of the ferromagnetic metallic layers 1 and 3, but also sensitively depends on the state of the surface of the protection film 4. When the metal probe 5 is brought close to the surface of the protection film 4, image potentials of the protection films 4 and the metal probe 5 overlap each other and effective potential for confining the quantum well electrons becomes deformed.

On the other hand, in a state in which distance between the surface of the protection film 4 and the metal probe 5 has been maintained at a predetermined value, voltage E₀ or −E₀ is rendered applicable between the multilayer film 41 and the metal probe 5. In other words, when a switch 17 or 18 is selectively turned ON and voltage E₀ or −E₀ is applied, confinement potential on the surface of the protection film 4 changes. As a result, since a boundary condition for confining the quantum well electrons changes, an energy level of quantum well electrons changes.

The energy of this quantum well level changes, whereby relative directions of magnetization of the ferromagnetic metallic layers 1 and 3 changes. In a case where the ferromagnetic metallic layer is made of Co and the non-magnetic metallic layer is made of Pt, the direction of magnetization is perpendicular to the film surface, and it is possible to control the quantum well level likewise.

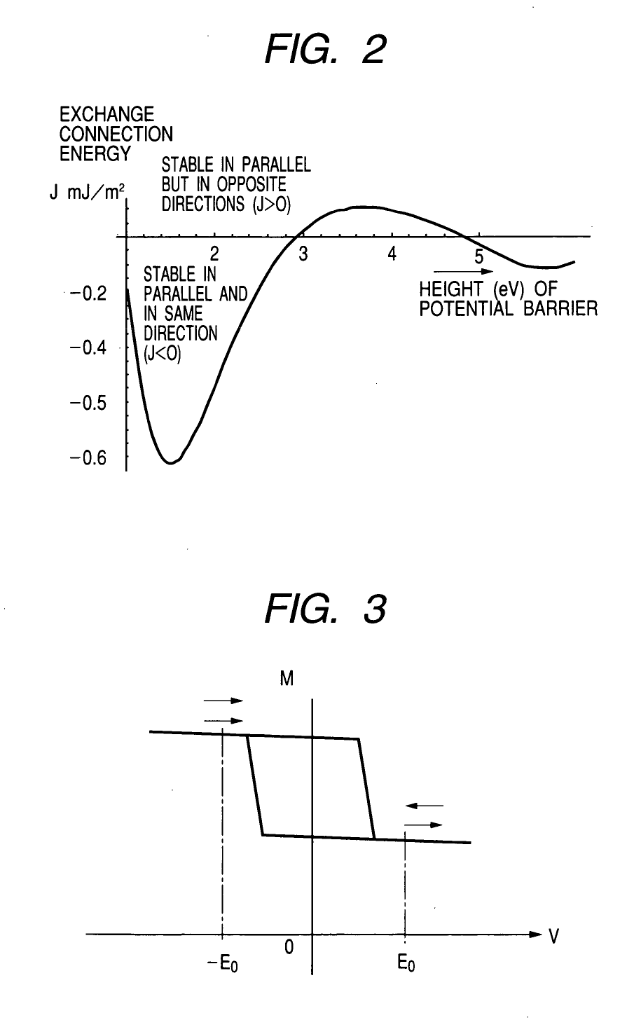

FIG. 2 is a view showing a calculation example of magnitude of a magnetic exchange interaction J exerting on between ferromagnetic metallic layers 1 and 3 when height (eV) of a potential barrier on the surface of a multilayer film 41 without protection film 4 has been changed due to distance between the metal probe 5 and the surface of the multilayer film 41. The height of the potential barrier is changed, whereby the confinement condition of the quantum well state which occurs in the ferromagnetic metallic layer 1/non-magnetic metallic layer 2/ferromagnetic metallic layer 3 changes through a change in a reflection phase in the interface. Where the ferromagnetic metallic layer 1, the non-magnetic metallic layer 2 and the ferromagnetic metallic layer 3 are made of Fe, Au and Fe respectively, and each film thickness is 1.43 nm, 2.04 nm and 1.43 nm respectively.

When the magnetic exchange interaction J is positive, in a relative direction of magnetization of the ferromagnetic metallic layers 1 and 3, a state in parallel but in the opposite directions is stable, and when J is negative, a state in parallel and in the same direction is stable. A work function of the surface of the multilayer film, distance between the metal probe 5 and the surface of the multilayer film 41, and the electric field are changed, whereby it is possible to set the height of a potential barrier on the surface of the multilayer film to a suitable value equal to or higher than 0eV. By changing the distance and the electric field between the metal probe 5 and the surface of the multilayer film 41, the shape of potential on the surface of the ferromagnetic metallic layer 3 is changed, whereby it is possible to make the magnetic exchange interaction J exerting on between the ferromagnetic metallic layers 1 and 3 positive or negative, and a change in exchange connection energy of about 0.1 mJ/m² sufficiently exceeds a coercive force of magnetization of the ferromagnetic metallic layer 3. In other words, it can be said that relative directions of magnetization of the ferromagnetic metallic layers 1 and 3 can be sufficiently rewritten by the metal probe 5.

In FIG. 2, at the height of potential barrier being about 4.8 eV, the magnetic exchange interaction J exerting on between the ferromagnetic metallic layers 1 and 3 is nearly zero. If the ferromagnetic metallic layer 3 is made of iron, J is nearly zero because the work function of iron is nearly 4.8 eV.

In FIG. 1, since the height of potential barrier has been 4.8 eV already even if there is no metal probe, design is made such that the height of potential barrier becomes about 4.8 eV, and within a range in which the magnetic exchange interaction J exerting on between the ferromagnetic metallic layers 1 and 3 becomes nearly zero, the target voltage e₀ is changed to bring the metal probe 5 close to the surface of the multilayer film 41. In this state, the switch 17 or 18 is selectively turned ON to apply voltage E₀ or −E₀. Since when the switch 17 is turned ON to set the potential of the metal probe 5 to positive (voltage E₀), the height of potential barrier becomes effectively low, in the relative directions of magnetization of the ferromagnetic metallic layers 1 and 3, the state in parallel but in the opposite directions becomes stable. On the other hand, when the switch 18 is turned ON and the potential of the metal probe 5 is made negative (voltage −E₀), in the relative direction of magnetization of the ferromagnetic metallic layers 1 and 3, the state in parallel and in the same direction becomes stable because the height of potential barrier becomes effectively high.

FIG. 3 is a view showing a direction of relative magnetization M of ferromagnetic metallic layers 1 and 3 when potential V of the metal probe 5 has been changed as described above. Since the ferromagnetic metallic layer 3 has a coercive force, such hysteresis as shown in FIG. 3 occurs in magnetization M, and the potential V of the metal probe 5 is changed, whereby it is possible to write in the direction of magnetization. FIG. 3 shows storage in a state in parallel and in the same direction at voltage V of −E₀ and storage in a state in parallel but in the opposite directions, and storage in a state in parallel and in opposite directions at voltage V of E₀.

In this respect, this writing is performed in a state in which the metal probe 5 has been held at a location whereat the height of potential barrier becomes about 4.8 eV with respect to the surface of the multilayer film 41. Therefore, when the position of the magnetic storage disk 50 is changed, in other words, even if the metal probe 5 is not located at the writing position since the address of the storage domain has been changed, there is no possibility that the writing result will be affected because the height of potential barrier remains unchanged.

As can be seen by referring to FIG. 2, even if the height of potential barrier is about 2.9 eV, the magnetic exchange interaction J exerting on between ferromagnetic metallic layers 1 and 3 is nearly zero. Therefore, even if the height of potential barrier is about 2.9 eV, it is possible to write due to the above-described voltage at the height of potential barrier being about 4.8 eV, and to maintain the memory. Even in this case, even if the metal probe 5 is not located at the writing position, it is necessary to control the work function on the surface of the multilayer film 41 such that the height of potential barrier remains at 2.9 eV.

The above-described description has been made of a case without the protection film 4, but the similar result can be obtained even in a case with the protection film 4. For example, in the case where there is provided the protection film 4, each film thickness will be set so as to have such height of potential barrier that the magnetic exchange interaction J becomes nearly zero, or the work function on the surface of the multilayer film will be controlled. The work function on the surface of the multilayer film can be controlled by adhering alkali metal such as Cs and Ba, alkali earth metal, their oxide and the like to the surface of the multilayer film.

(Second Embodiment)

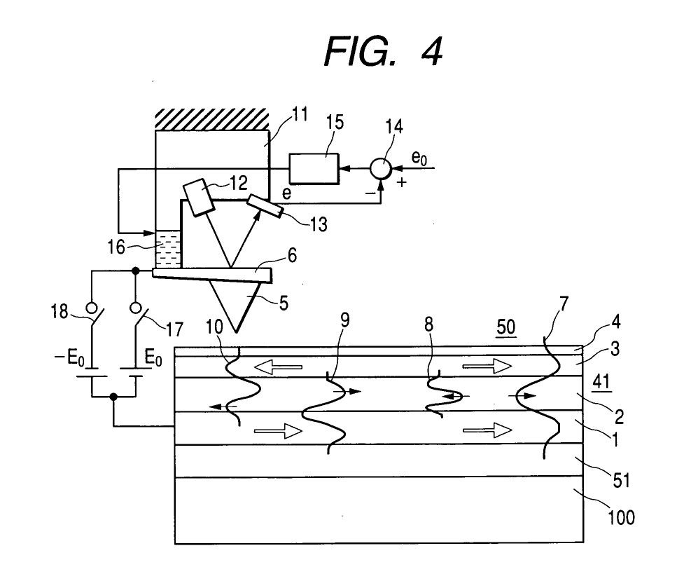

With reference to FIG. 4, the description will be made of the second embodiment. The second embodiment is different from the first embodiment only in that in addition to the multilayer film 41 composed of the ferromagnetic metallic layer 1, the non-magnetic metallic layer 2, the ferromagnetic metallic layer 3, and the protection film 4 which have been formed on the substrate 100, the magnetic storage disk 50 is formed with an anti-ferromagnetic layer 51 between the substrate 100 and the ferromagnetic metallic layer 1.

Even in the second embodiment, as in the case of the first embodiment, when directions of magnetization of the ferromagnetic metallic layers 1 and 3 are in parallel and in the same direction as shown in the right half portion of FIG. 4, an electron having electron spin parallel with the magnetization is substantially confined in the nonmagnetic metallic layer 2 as indicated by a reference symbol 8. An electron having electron spin in a direction opposite to the magnetization is confined in the entire multilayer film 41 as indicated by a reference symbol 7. On the other hand, when directions of magnetization of the ferromagnetic metallic layers 1 and 3 are in parallel but in opposite directions as shown in the left half portion of FIG. 4, an electron is confined in the films 1 to 2 as indicated by a reference symbol 9 depending upon the direction of the spin, or is confined in the films 2 to 3 as indicated by a reference symbol 10.

The second embodiment is different from the first embodiment only in that the direction of magnetization of the ferromagnetic metallic layer 1 is fixed because there is formed an anti-ferromagnetic layer 51, and is the same as the first embodiment in the writing using the metal probe 5.

(Third Embodiment)

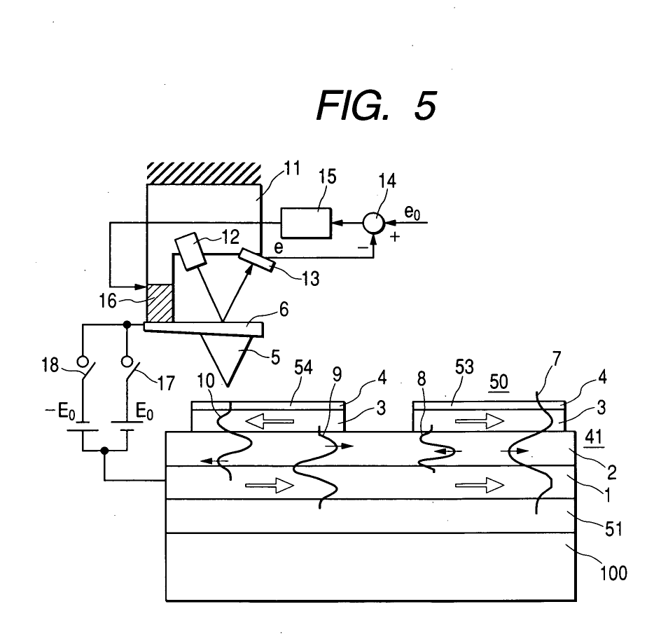

With reference to FIG. 5, the description will be made of the third embodiment. In the third embodiment, the protection film 4 and the ferromagnetic layer 3 are patterned in a dot shape as shown in FIG. 5 by means of the lithography technique using the semiconductor fabrication technique such as resist patterning, ion-milling and resist removal during formation of each layer, and pillar-shaped nanopillars 53 and 54 are formed. In this case, a nanopillar including the non-magnetic metallic layer 2, the ferromagnetic layer 1 and the anti-ferromagnetic layer 11 may be constituted, and it does not contribute much to the improvement in the storage characteristic due to the formation of the nanopillar.

As can be easily understood by comparing FIG. 5 with FIG. 4, the third embodiment is different from the second embodiment only in that domains which become individual units of storage have been patterned in a dot shape, and pillar-shaped nanopillars 53 and 54 corresponding to the storage domain are formed. In this case, the nanopillar means a circular or ellipse shape, or a square or rectangular shape, pillar in units of nm in size on a plane. Even in the third embodiment, it may be possible to have no anti-ferromagnetic layer 11 as in the case of the first embodiment.

An electron in the vicinity of a Fermi-level in the multilayer film 41 forms a quantum well state as described in the first and second embodiments, but the third embodiment is different from the first and second embodiments in that these are confined in the nanopillars 53 and 54. Since the quantum well formed is confined in the nanopillars 53 and 54, it becomes difficult to be affected by the storage domain adjacent thereto to improve the storage characteristic.

The nanopillars are preferably arranged and constituted so as to be able to correspond to the current storage format of the magnetic storage disk. Also, there may be used a state in which a gap has remained between each pillar as shown in the figure, but it is preferable that the gap is bridged with material having no magnetic properties like an insulator such as alumina or a semiconductor such as Si. In a state in which the gap remains, when the metal probe 5 crosses between nanopillars in response to movement of the storage bit, the metal probe 5 follows the gap, and therefore, there is a possibility that the metal probe 5 or the nanopillar is damaged, and the moving speed is to be restricted.

(Fourth Embodiment)

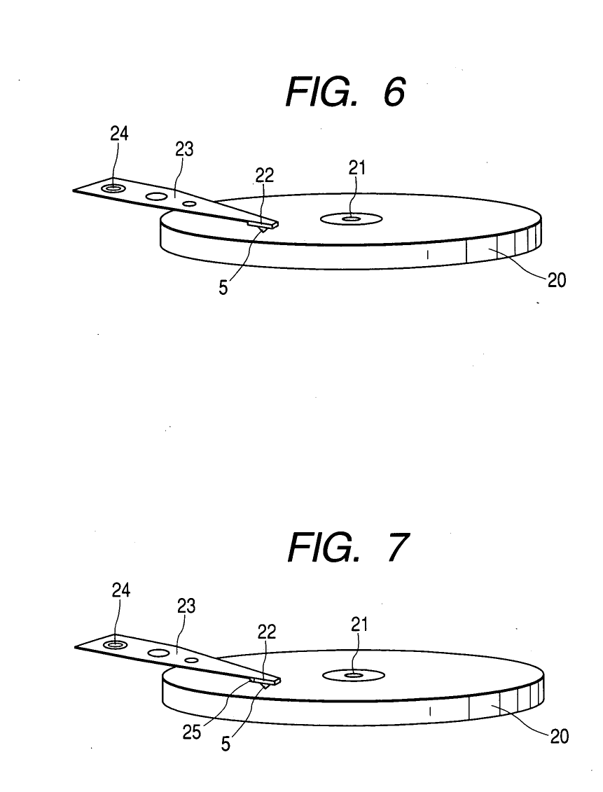

FIG. 6 is a perspective view showing an outline of the structure of the magnetic recording device of the fourth embodiment. The multilayer film 41 composed of the anti-ferromagnetic layer 51, the ferromagnetic metallic layer 1, the non-magnetic metallic layer 2, the ferromagnetic metallic layer 3, and the protection film 4 of each of the above-described embodiments is formed as the disk-shaped recording medium 20. The metal probe 5 to be provided to oppose to the multilayer film 41 is mounted to the lower portion of a slider 22 provided at the tip end of the arm 23. Reference numeral 24 designates a rotating supporting shaft of the arm 23. When the disk-shaped recording medium 20 is rotated with a center of rotation 21 as an axis by a motor in the same manner as a general magnetic disk, the slider 22 comes up by predetermined distance. Therefore, the metal probe 5 opposes to the multilayer film 41 at substantially constant distance as described in the first to third embodiments.

If the substrate side of the disk-shaped recording medium 20 is made conductive, voltage is applied to the metal probe 5 through the arm 23, and an electric field is applied to the multilayer film 41 as described in the first to third embodiments, the multilayer film 41 will be enabled to be magnetic-recorded in the direction of magnetization. If the rotation of the disk-shaped recording medium 20 and the position of the metal probe 5 are controlled in the same manner as the general magnetic disk and the potential at the metal probe 5 is controlled correspondingly to a recording signal, a magnetic recording device similar to the general magnetic disk will be able to be realized.

On the other hand, the direction of magnetization which has been written on the disk-shaped recording medium 20 by means of the metal probe 5 can be read through fine tunnel current which flows through between the metal probe 5 and the disk-shaped recording medium 20. This is because as described in the first to third embodiments, a quantum well state which occurs is different depending upon whether relative directions of magnetization of two ferromagnetic layers are in parallel and in the same direction or in parallel but in opposite directions, and the energy of quantum level, that is, state density of the disk-shaped recording medium 20 differs with whether the directions of magnetization are in parallel and in the same direction or in parallel but in opposite directions. FIG. 6 does not specifically exemplify means for flowing the tunnel current and means for detecting it. However, in the same manner as the voltage source E₀ for recording information shown in, for example, FIG. 1, it is advisable to apply voltage to between the metal probe 5 and the multilayer film 41 and detect current, which flows in response thereto.

In this respect, it goes without saying that even the magnetic recording device of the fourth embodiment is capable of dispensing with the anti-ferromagnetic layer 51 in the same manner as each of the above-described embodiments.

(Fifth Embodiment)

FIG. 7 is a perspective view showing an outline of the structure of a magnetic recording device of the fifth embodiment. In FIG. 7, reference numeral 25 designates a GMR element (Giant Magneto-resistance Effect Element). Others are the same as in the fourth embodiment. The fifth embodiment is different from the fourth embodiment only in that the direction of magnetization of the disk-shaped recording medium 20 in the fourth embodiment is read by means of a change in current flowing through the GMR element. Writing in the direction of magnetization due to the metal probe 5 on the disk-shaped recording medium 20 is the same as in the fourth embodiment. In this case, it goes without saying that in place of the GMR element 25, a TMR element (Tunnel Magneto-resistance Effect Element) may be used.

In this respect, it goes without saying that even the magnetic recording device of the fifth embodiment is capable of dispensing with the anti-ferromagnetic layer 51 in the same manner as each of the above-described embodiments.

(Sixth Embodiment)

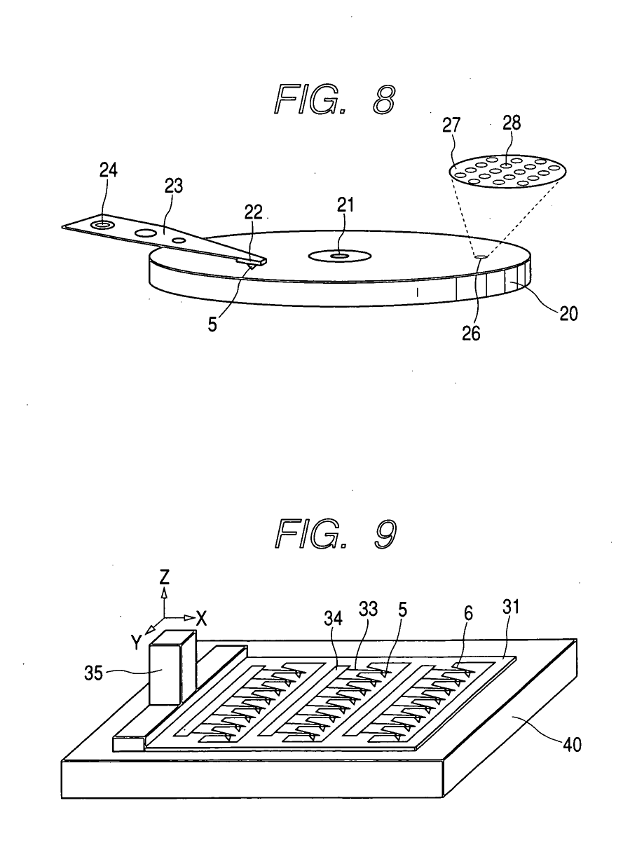

FIG. 8 is a perspective view showing an outline of the structure of a magnetic recording device of the sixth embodiment. The sixth embodiment shows an example in which the disk-shaped recording medium 20 of the fourth embodiment shown in FIG. 6 has been constituted by nanopillar-shaped storage units 53 and 54 composed of the anti-ferromagnetic layer 51, the ferromagnetic metallic layer 1, the non-magnetic metallic layer 2, the ferromagnetic metallic layer 3 and the protection film 4 which have been described in the third embodiment (FIG. 5), and the other components are the same as in the fourth embodiment. FIG. 8 shows schematically a state in which the nanopillar 28 is arranged on concentric circles around a center of rotation 21 on a domain 27 obtained by enlarging a partial domain 26 of the disk-shaped recording medium 20.

Even in the sixth embodiment, by means of lifting power due to the slider 22 mounted at the tip end of the arm 23, the metal probe 5 maintains a fixed interval with the disk-shaped recording medium 20, and the metal probe 5 is capable of writing on the nanopillar 28 at any position by magnetization. On the other hand, the direction of magnetization written on the nanopillar 28 by the metal probe 5 can be read through fine tunnel current flowing through between the metal probe 5 and the nanopillar 28. Also, it may be possible to mount the GMR element 25 or the TMR element to the tip end of the arm 23 as shown in the fifth embodiment for reading the direction of magnetization of the nanopillar 28 of the disk-shaped recording medium 20.

In this respect, it goes without saying that even the magnetic recording device of the sixth embodiment is capable of dispensing with the anti-ferromagnetic layer 51 in the same manner as each of the above-described embodiments.

(Seventh Embodiment)

FIG. 9 is a perspective view showing an outline of the structure of a magnetic recording device of the seventh embodiment. The seventh embodiment is a magnetic recording device constituted by using: a recording medium 40 using the multilayer film 41 composed of the anti-ferromagnetic layer 51, the ferromagnetic metallic layer 1, the non-magnetic metallic layer 2, the ferromagnetic metallic layer 3 and the protection film 4 which have been described in the second and third embodiments; and a position controlling mechanism of the metal probe 5 which has been adopted in the first to third embodiments. The recording medium 40 may be constituted by a storage unit composed of nanopillars described in the sixth embodiment.

The recording medium 40 is fixed. On a surface on which the multilayer film 41 of the recording medium 40 has been formed, a substrate 31 has been provided in opposite. On the substrate 31, a plurality of leaf springs 6 are provided in the X and Y directions respectively. At the tip ends of the respective leaf springs 6, there are provided metal probes 5. The substrate 31 is capable of moving within a plane (X-Y direction) of the recording medium 40 and in the vertical (Z) direction thereof by means of a movable mechanism 35. Within a range within which the substrate 31 relatively moves with respect to the recording medium 40, the metal probes 5 in the X direction and in the Y direction move at maximum up to one storage unit before the neighboring metal probe 5 writes or reads data. Here, control of the distance between the metal probe 5 and the multilayer film 41 of the recording medium 40 has been omitted, but for example, optical lever type AFM exemplified in examples VI and VII of the patent literature 2 can be utilized.

To each metal probe 5, there are connected electric wire 33 and a signal processing circuit 34, and an electric field is applied between the recording medium 40 and the metal probe 5, whereby it is possible to write in the direction of magnetization of the storage medium 40. The direction of magnetization written on the storage medium 40 can be read through a change in tunnel current in the same manner as in the fourth embodiment.

In this respect, it goes without saying that even the magnetic recording device of the seventh embodiment is capable of dispensing with the anti-ferromagnetic layer 51 in the same manner as each of the above-described embodiments.

Thus, in summary according to the present invention, it is possible to provide a non-contact magnetization recording method at high-density due to an electric field and with low power consumption, and an apparatus for the same. The embodiments and disclosure above are not meant to be limiting to the scope of the presently disclosed invention or envisioned equivalents thereto.

What is claimed is:

1. A magnetization control method, comprising:
providing at least one metal probe;
providing a substrate;
providing on the substrate a multilayer film including a first ferromagnetic metallic layer, a non-magnetic metallic middle layer, and a second ferromagnetic metallic layer located facing said metal probe;
maintaining the distance between said metal probe and said multilayer film as substantially constant so as not to contact said multilayer film;
providing an electric field between said metal probe and said multilayer film; and
controlling the electric field to change at least one direction of magnetization of said ferromagnetic metallic layers.

2. The magnetization control method according to claim 1, further comprising providing an anti-ferromagnetic layer between the first ferromagnetic layer and the substrate.

3. An information recording apparatus, comprising:
at least one metal probe,
a multilayer film including a first ferromagnetic metallic layer, a middle non-magnetic metallic layer, and a second ferromagnetic metallic layer facing said metal probe,
wherein the probe is structured so that a distance between said metal probe and said multilayer film is maintained substantially constant so as not to contact said multilayer film and an electric field between said metal probe and said multilayer film is controlled to change at least one direction of magnetization of said ferromagnetic metallic layers for recording information corresponding to said electric field.

4. An information recording apparatus, comprising:
at least one metal probe,
a multilayer film comprising a ferromagnetic metallic layer, a middle non-magnetic metallic layer, and a ferromagnetic metallic layer for facing said metal probe;
wherein said metal probe is structured so that a distance between said metal probe and said multilayer film is maintained substantially constant so as not to contact said multilayer film;
a controller wherein an electric field between said metal probe and said multilayer film is controlled to change at least one direction of magnetization of said ferromagnetic metallic layers for recording information corresponding to said electric field;
and wherein said metal probe is structured so that between said metal probe and said multilayer film, there is an applied voltage for flowing tunnel current through to read information recorded by a change in said tunnel current corresponding to a change in a direction of magnetization due to said electric field which corresponds to said information.

5. The information recording apparatus according to claim 4, wherein said multilayer film is formed as a disk-shaped recording medium for rotation;
said metal probe is provided to oppose said multilayer film at a tip end of an arm, one end of which is rotatably supported and the other end side of which is extended to said disk-shaped recording medium;
and at the tip end of said arm, there is further provided a slider; whereby a distance between said metal probe and said multilayer film is maintained substantially constant by said slider so the metal probe will not contact said multilayer film;
wherein said metal probe is structured so that an electric field between said metal probe and said multilayer film is controlled to change at least one direction of magnetization of said ferromagnetic metallic layer for recording information corresponding to said electric field;
and wherein aid metal probe is structured so that between said metal probe and said multilayer film, there is applied a voltage for flowing tunnel current through to read information recorded by a change in said tunnel current corresponding to a change in a direction of magnetization due to an electric field which corresponds to said information.

6. The information recording apparatus according to claim 5, wherein in place of said tunnel current, information recorded by a provided GMR element or a TMR element located at the tip end of said arm is read.

7. The information recording apparatus according to claim 4, further comprising:
a plurality of metal probes arranged at predetermined intervals in place of said at least one metal probe,
a multilayer film including a ferromagnetic metallic layer, a middle non-magnetic metallic layer, and a ferromagnetic metallic layer for facing said plurality of metal probes, wherein a distance between said metal probes and said multilayer film is maintained substantially constant;
wherein an electric field between said metal probes and said multilayer film is controlled to change at least one direction of magnetization of said ferromagnetic metallic layer for recording information corresponding to said electric field every one of said plurality of metal probes and;
wherein said metal probes are structured so that between said metal probes and said multilayer film, there is an applied voltage for flowing tunnel current through to read information recorded by a change in said tunnel current corresponding to a change in a direction of magnetization due to an electric field which corresponds to said information from every one of said plurality of metal probes.

8. The information recording apparatus according to claim 3, wherein the ferromagnetic metallic layer of said multilayer film which faces said metal probe is made into domains which have been spatially divided in units of information to be recorded.

9. The information recording apparatus according to claim 3, further comprising providing an anti-ferromagnetic layer between the first ferromagnetic.layer and the substrate.
